(19) United States
(12) Patent Application Publication
(10) Pub. No.: US 2007/0284066 A1
(43) Pub. Date: Dec. 13, 2007

(54) Quick-block

(76) Inventor: Robert G. Peden, Saint Francisville, LA (US)

Correspondence Address: Galasso & Associates, LP, P.O. Box 26503, Austin, TX, 78755-0503, US

(21) Appl. No.: 11/451,046

(22) Filed: Jun. 12, 2006

(51) Int. Cl. B60J 1/20

(52) U.S. Cl. 160/370.22

(57) ABSTRACT

Quick-Block consists of a two-piece windshield cover that dispenses from two separate retractable housings on opposite sides of a dashboard and connects in the middle through the use of an attaching mechanism such as Velcro. When a driver parks his car, he or she simply pulls the covers from the housings and uses the Velcro hook and loop attaching mechanism to connect the covers over the windshield of a car. Suction cups mounted on the front edge of the driver's side cover hold the covers close against the windshield to accommodate the various contours of windshields. When a user is finished with the device and wants to remove it in order to drive the car, he or she detaches the suction cups and then disconnects the attaching mechanism to allow the covers to retract back into their respective housings.

### CROSS-REFERENCE TO RELATED APPLICATIONS

This Non-Provisional Patent Application does not claim priority to any U.S. provisional patent application or foreign patent application.

### FIELD OF THE DISCLOSURE

The disclosures made herein relate generally to the automobile accessories industry. The invention discussed herein is in the general classification of windshield covers.

### BACKGROUND

Millions of people utilize their automobiles everyday in the United States. When an automobile is not in use, the driver must park it somewhere. Often times a shady parking spot or covered garage is not available, forcing the driver to leave the automobile in a location susceptible to the weather, including direct sunlight.

When the car is parked it can be subject to extreme temperatures, especially in the summer months of the year. Direct sunlight can heat the steering wheel and dashboard of the car to levels that are uncomfortable or even dangerous for humans should they need to make contact with components on or near the dashboard of the car. The sunlight can also damage components of the car after prolonged exposure.

Currently, a variety of sunshades are available for placing on the windshield when a car is parked. However, these devices are time-consuming to use, bulky and difficult to maneuver. These devices also need to be stored somewhere within the car when they are not in use.

Hence, there is a need in the art for an easy to use, affordable and effective windshield cover to prevent sunlight from heating and damaging the steering wheel or components on or near the dashboard of a car.

### SUMMARY OF THE DISCLOSURE

Quick-Block consists of at least some of the following: a two-piece windshield cover that dispenses from two separate retractable housings on opposite sides of a dashboard and connects in the middle through the use of an attaching mechanism such as Velcro.

The principal object of this invention is to provide a windshield cover that will provide shade from the sun for a car when it is parked to prevent the steering wheel and dashboard components from excessive heating.

Another object of this invention is to provide a windshield cover that will protect the dashboard components of a car from damage from direct sunlight.

Another object of this invention is to provide a windshield cover that will store conveniently within a housing after use.

Yet another object of this invention is to provide a windshield cover that is easy to use and effective in preventing direct sunlight from reaching the steering wheel and other portions of the dashboard of the car.

### BRIEF DESCRIPTION OF THE DRAWINGS

FIG. 1 depicts a perspective view of the preferred embodiment of the present invention.

FIG. 2 depicts a perspective view of the attaching mechanism of the present invention.

### DETAILED DESCRIPTION OF THE DRAWINGS

Quick-Block utilizes at least some of the following: a two-piece windshield cover that dispenses from two separate retractable housings on opposite sides of a dashboard and connects in the middle through the use of an attaching mechanism such as Velcro.

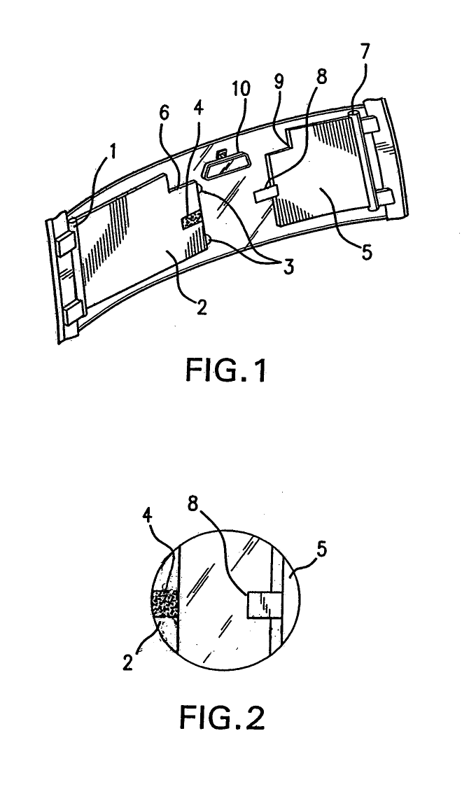

These components will now be described in further detail in conjunction with FIGS. 1-2.

FIG. 1 depicts the preferred embodiment of the present invention. A first plastic, cylindrical and spring-loaded housing 1 containing a first cover 2 attaches to the vertical doorpost on the driver's side of the car. The first cover 2 is roughly rectangular in shape and made of vinyl in the preferred embodiment, although it could also be made of leather or other similar material. The outside or front portion (the side closest to the windshield when the device is in use) of the first cover 2 has a reflective surface. The first cover 2 has two suction cups 3 at the two corners of the outer ends. The first cover 2 also has a Velcro loop 4 attached to the center, outer end. The Velcro loop 4 is used to attach the first cover 2 to a second cover 5. The spring-loaded housing 1 permits the first cover 2 to gently retract when it is released. The first cover 2 also has a cup-shaped cut-out 6 on the upper right hand side to permit it to be conveniently maneuvered around the rear view mirror 10.

A second plastic, cylindrical and spring-loaded housing 7 containing the second cover 5 attaches to the vertical doorpost on the passenger's side of the car. The second cover 5 is also roughly rectangular in shape and made of vinyl in the preferred embodiment, although it too could be made of leather or other similar material. The outside or front portion of the second cover 5 has the same type of reflective surface as that on the first cover 2. The second cover 5 has a Velcro hook 8 that is used to attach the second cover 5 to the first cover 2. The second cover has a second cup-shaped cut-out 9 on the upper left hand side to permit it to be conveniently maneuvered around the rear view mirror 10.

FIG. 2 depicts a perspective view of the preferred embodiment of the attaching mechanism of the present invention. A Velcro loop 4 located on the outer edge of the first cover 2 and a Velcro hook 8 located on the outer edge of the second cover 5 permit the two covers to connect.

Quick-Block operates in a similar manner as a retractable window shade for use in homes. When a driver or passenger wants to use the invention, he or she simply pulls the covers from the housings and uses the Velcro hook and loop attaching mechanism to connect the two covers over the windshield of a car. The attaching mechanism allows the covers to withstand the retracting force within the housings. The suction cups mounted on the front edge of the driver's side cover hold the cover close against the windshield to accommodate the various contours of a windshield to allow for better sunray blockage.

When a user is finished with the device and wants to remove it in order to drive the car, he or she detaches the suction cups and then disconnects the attaching mechanism to allow the covers to retract back into their respective housings.

The components of Quick-Block may vary widely but will likely utilize plastic, metal, and vinyl or leather components. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of Quick-Block can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

The size of Quick-Block may vary widely. The preferred embodiment is approximately two to three feet in height and forty-eight inches in length and less than a quarter of an inch thick. It should be obvious that any color, shape or size windshield cover or housing could be utilized with the present invention. It should also be obvious that any style attaching mechanism could be utilized for connecting the two sides of the cover such as a zipper and guide or button and hole arrangement. It should further be obvious that the invention could have only one housing and one cover that connects directly to the opposite side of the windshield.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A car accessory comprising:
(a) a first housing containing a first cover that attaches to an interior portion of a vehicle;
(b) a second housing containing a second cover that attaches to a second interior portion of the vehicle;
(c) a first attaching mechanism located on the periphery of the first cover; and
(d) a second attaching mechanism located on the periphery of the second cover.

2. The car accessory of claim 1 wherein the first cover and the second cover are approximately rectangular.

3. The car accessory of claim 1 wherein the first cover and the second cover are made of vinyl.

4. The car accessory of claim 1 wherein the first cover and the second cover are made of leather.

5. The car accessory of claim 1 wherein the first cover has a first reflective surface on the outside and the second cover has a second reflective surface on the outside.

6. The car accessory of claim 1 wherein the first housing and the second housing are spring-loaded.

7. The car accessory of claim 1 wherein the first housing and second housing are plastic.

8. The car accessory of claim 1 wherein the first housing and second housing are cylindrical.

9. The car accessory of claim 1 wherein the first cover has a cup-shaped cut-out on the upper right corner and the second cover has a cup-shaped cut-out in the upper left corner.

10. The car accessory of claim 1 further comprising
at least one suction cup located at the outer edge of the first cover.

11. The car accessory of claim 1 wherein the first attaching mechanism is a velcro hook and the second attaching mechanism is a velcro loop.

12. The car accessory of claim 1 wherein the first attaching mechanism is a button and the second attaching mechanism is a hole.

13. The car accessory of claim 1 wherein the first attaching mechanism is a zipper and the second attaching mechanism is a guide.

14. A car accessory comprising:
(a) a housing containing a cover that attaches to a first interior portion of a vehicle; and
(b) a first attaching mechanism located on the cover that permits the cover to connect to a second attaching mechanism located in a second interior portion of the vehicle.

15. A car accessory comprising:
(a) a first spring-loaded housing containing a first cover that attaches to a first doorpost of a vehicle wherein the first spring-loaded housing is plastic and cylindrical and the first cover is vinyl and approximately rectangular and has a first reflective surface on one side;
(b) a second spring-loaded housing containing a second cover that attaches to a second doorpost of a vehicle wherein the second spring-loaded housing is plastic and cylindrical and the second cover is vinyl and approximately rectangular and has a second reflective surface on one side;
(c) a first attaching mechanism located on the periphery of the first cover and a second attaching mechanism located on the periphery of the second cover;
(d) a first suction cup attached to an upper corner of the first cover and a second suction cup attached to the lower corner of the first cover;
(e) a first cup-shaped cut-out located on the upper corner of the first cover and a second cup-shaped cut-out located on the upper corner of the second cover.
